(19) United States
(12) Patent Application Publication
(10) Pub. No.: US 2026/0285430 A1
(43) Pub. Date: Sep. 24, 2026

(54) BICYCLE STAND

(71) Applicant: Fat Squirrel Limited, Stourbridge, West Midlands (GB)

(72) Inventors: Matthew Harvey LAIGHT, Stourbridge, West Midlands (GB); Simon Brian LAIGHT, Stourbridge, West Midlands (GB)

(73) Assignee: Fat Squirrel Limited, Stourbridge, West Midlands (GB)

(21) Appl. No.: 19/473,739

(22) PCT Filed: Apr. 11, 2024
(86) PCT No.: PCT/EP2024/059907

§ 371 Date: Oct. 8, 2025

(30) Foreign Application Priority Data
Apr. 18, 2023 (GB) 2305677.3

(51) Int. Cl. B62H 3/08

(52) U.S. Cl. CPC B62H 3/08

(57) ABSTRACT

A folding stand (1) for locating a bicycle is foldable to a folded configuration and deployable to a deployed configuration. The stand (1) has at least first, second and third members (10, 20. 30). The first member (10) is a lower member in the deployed configuration and has a front pair of cooperating locating surfaces (11) and a rear pair of cooperating locating surfaces (12) for locating the wheel of a bicycle. The second member (12) is a rear, generally upwardly directed member in the deployed configuration of the stand (1). The third member (30) is a cross-member in the deployed configuration of the stand (1). The first member (10) is pivotally connected at a first end to a first end of the third member (30) and the third member (30) is pivotally connected at a second end to a first end of the second member (20). The first member (10) is connectable at a second end to the second member (20).

### TECHNICAL FIELD

The present disclosure relates to a folding stand for a bicycle.

### BACKGROUND

Numerous arrangements for stands for bicycles and other wheeled vehicles and the like are known. Examples are disclosed in our GB2559347A and U.S. Pat. No. 10,384,734B2, the entire contents of which are hereby incorporated by reference.

### SUMMARY

According to an aspect disclosed herein, there is provided a folding stand for locating a bicycle, the stand being foldable to a folded configuration and deployable to a deployed configuration, the stand comprising
at least first, second and third members;
the first member being a lower member in the deployed configuration of the stand and having a front pair of cooperating locating surfaces and a rear pair of cooperating locating surfaces for locating the wheel of a bicycle between the cooperating surfaces;
the second member being a rear, generally upwardly directed member in the deployed configuration of the stand;
the third member being a cross-member in the deployed configuration of the stand;
the first member being pivotally connected at a first end to a first end of the third member;
the third member being pivotally connected at a second end to a first end of the second member;
the first member being connectable at a second end to the second member;
such that the stand can be folded to the folded configuration by disconnecting the second end of the first member from the second member and folding the first member about the pivotal connection with the third member and folding the second member about the pivotal connection with the third member, wherein the first, second and third members are stacked generally one above the other in the folded configuration; and
such that the stand can be deployed to the deployed configuration by unfolding the second member about the pivotal connection with the third member and unfolding the first member about the pivotal connection with the third member and connecting the second end of the first member to the second member, wherein the first member is generally horizontal, the second member is generally upwardly directed and the third member is generally inclined to form a cross-member between the first and second members.

The stand can be deployed when needed and easily folded away when not needed. This may be convenient if the stand is being transported in a vehicle or the like, or is being used in a dwelling or other location where a bicycle is being stored.

In an example, the first, second and third members are substantially rigid.

The stand and the front pair of cooperating locating surfaces and the rear pair of cooperating locating surfaces may be spaced and arranged so that the wheel of a bicycle is held off the ground when the wheel is located between the pairs of locating surfaces.

In an example, the third member provides a third pair of cooperating locating surfaces at or towards the second end of the third member for locating the wheel of a bicycle between the cooperating surfaces.

The third pair of cooperating locating surfaces provide additional support and stability for locating the wheel of a bicycle.

In an example, the third pair of cooperating locating surfaces are provided on a sliding member which is arranged to be slidable along the third member to allow the location of the third pair of cooperating locating surfaces on the third member to be adjusted.

This allows wheels of different sizes to be accommodated by the stand more easily.

In an example, the stand comprises a seat post support for supporting a seat post of a bicycle, the seat post support being mounted at or towards the first end of the second member to project beyond the first end of the second member when the stand is in the deployed configuration to receive a seat post of a bicycle when the bicycle is stored in a generally vertical orientation in the deployed stand.

The seat post support is particularly useful when the bicycle is rotated generally from a horizonal orientation to be stored in a generally vertical orientation in the deployed stand.

In an example, the seat post support is arranged to be slidable along the second member to allow the location of the seat post support on the second member to be adjusted.

This allows bicycles of different sizes and different configurations to be accommodated by the stand when stored in a generally vertical orientation in the deployed stand. The seat post support may be provided as a separate slider component which is slidably fixed to the second member.

In an example, the stand comprises a rearwardly facing projection on the seat post support.

In this example, when a bicycle is stored vertically in the stand, a user can place a hand around the rearwardly facing projection and the seat post to grasp and hold the bicycle and stand together. Alternatively, the user can wrap a strap or the like around the rearwardly facing projection and the seat post to hold the bicycle and stand together. Either way, the user can then move and manoeuvre the bicycle and stand, whilst securing the bicycle in the stand during movement. In the case that the seat post support is provided by a separate slider component, the rearwardly facing projection may be provided on the slider component so as to move up and down with the slider component during adjustment.

In an example, the stand comprises at least one wheel or roller on the first member to facilitate movement of the stand by a user.

This is particularly advantageous in the case that the stand has a rearwardly facing projection below the seat post support as described above as the user can grasp and hold the bicycle and stand together and move them more easily, in the manner of a wheeled trolley or wheelbarrow or the like.

In an example, the first member and the second member are arranged such that the first member is connectable to the second member at a number of different locations along the first member, such that the angle of inclination of the second member is adjustable.

This allows bicycles of different sizes and different configurations to be accommodated. This is particularly suitable for the case when the stand has a seat post support as described above as varying the angle of inclination of the second member allows the relative location of the seat post support to be adjusted.

In an example, the second member has a cross bar towards the second end of the second member and the second end of the first member lies across the cross bar when the stand is in the deployed configuration, the first member comprising a plurality of ridges or stops on a lowermost surface towards the second end of the first member which provide the different locations along the first member and which respectively abut against the cross bar of the second member when the stand is in the deployed configuration.

The cross bar towards the second end of the second member may be provided as the lower wall of an opening in the second member through which the second end of the first member passes.

There is also disclosed herein a handlebar stabiliser for fitting to a bicycle stand to stabilise a handlebar of a bicycle located in the stand, the handlebar stabiliser comprising:
an elongate member having first and second ends;
a jaw for fitting over a handlebar of a bicycle, the jaw being at or towards the first end of the elongate member and projecting outwardly of the elongate member;
a biasing weight at or towards the second end of the elongate member; and
a pivot mount projecting outwardly of the elongate member between the first and second ends;
the biasing weight being spaced from the longitudinal axis of the elongate member such that when the pivot mount of the handlebar stabiliser is fitted to a stand, the handlebar stabiliser is arranged such that the elongate member is generally vertical with the biasing weight being lowermost and biasing the elongate member to rotate about the pivot point provided by the pivot mount to bias the jaw into engagement with a handlebar of a bicycle located generally vertically in the stand.

The pivot mount may project generally perpendicularly to the longitudinal axis of the elongate member. The jaw may project generally perpendicularly to the longitudinal axis of the elongate member.

In an example, the pivot mount projects in a first direction outwardly of the elongate member and the biasing weight is spaced from the elongate member in the first direction such that the centre of mass of the handlebar stabiliser is to the same side of the elongate member as the jaw, the biasing weight and the pivot mount and beyond a pivot point provided by the pivot mount.

In an example, the elongate member is telescopic to allow the overall length of the elongate member to be adjusted.

In an example, the jaw provides a generally V or other tapering shape recess which receives the handlebar of a bicycle, the entrance to the recess comprising a pair of opposed flat surfaces which that are parallel to each other and perpendicular to the longitudinal axis of the elongate member.

There is also provided in combination, a handlebar stabiliser as described above and a bicycle stand.

In general, the bicycle stand may be a stand as described above or some other stand.

In an example, the bicycle stand has a lower member having a front pair of cooperating locating surfaces and a rear pair of cooperating locating surfaces for locating the wheel of a bicycle between the cooperating surfaces; the lower member having a slot which receives the biasing weight of the handlebar stabiliser to restrain sideways movement of the handlebar stabiliser while permitting pivoting movement of the handlebar stabiliser.

In an example, the bicycle stand has a rear, generally upwardly directed member, the rear member having a slot which receives the pivot mount of the handlebar stabiliser.

In an example, the slot in the lower member and the slot in the rear member are located laterally displaced from a line between the front pair of cooperating locating surfaces and the rear pair of cooperating locating surfaces of the lower member so that the handlebar stabiliser is located parallel to and spaced from the plane of a bicycle located generally vertically in the stand such that the jaw fits over the handlebar of the bicycle at a position spaced from the centre of the handlebar.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a perspective view of a first example of a stand according to the present disclosure in a deployed configuration;

FIG. 2 shows schematically a rear view of the first example of the stand in the deployed configuration;

FIG. 3 shows schematically a side elevation of the first example of the stand in the deployed configuration in a first arrangement;

FIG. 4 shows schematically a side elevation of the first example of the stand in the deployed configuration in a second arrangement;

FIG. 5 shows schematically a side elevation of a bicycle located horizontally in the first example of the stand;

FIG. 6 shows schematically a perspective view of the bicycle located horizontally in the first example of the stand;

FIG. 7 shows schematically a side elevation of a bicycle located vertically in the first example of the stand;

FIG. 8 shows schematically a perspective view of the bicycle located vertically in the first example of the stand;

FIGS. 9 to 11 respectively show a plan view from above, a plan view from below and a side elevation of the first example of the stand in a folded configuration;

FIGS. 12A and 12B show side elevations of an example of a handlebar stabiliser according to the present disclosure in extended and retracted configurations respectively;

FIG. 13 shows schematically a perspective view of the example of the handlebar stabiliser fitted to a second example of a stand according to the present disclosure in a deployed configuration;

FIG. 14 shows schematically a rear view of the second example of a stand according to the present disclosure in a deployed configuration;

FIG. 15 shows schematically a side elevation of the example of the handlebar stabiliser fitted to the second example of the stand in the deployed configuration;

FIGS. 16 to 18 show schematically detailed perspective views of portions of the example of the handlebar stabiliser fitted to the second example of the stand; and

FIGS. 19 and 20 show schematically a side elevation and a perspective view respectively of a bicycle located vertically in the second example of the stand and use of the handlebar stabiliser.

### DETAILED DESCRIPTION

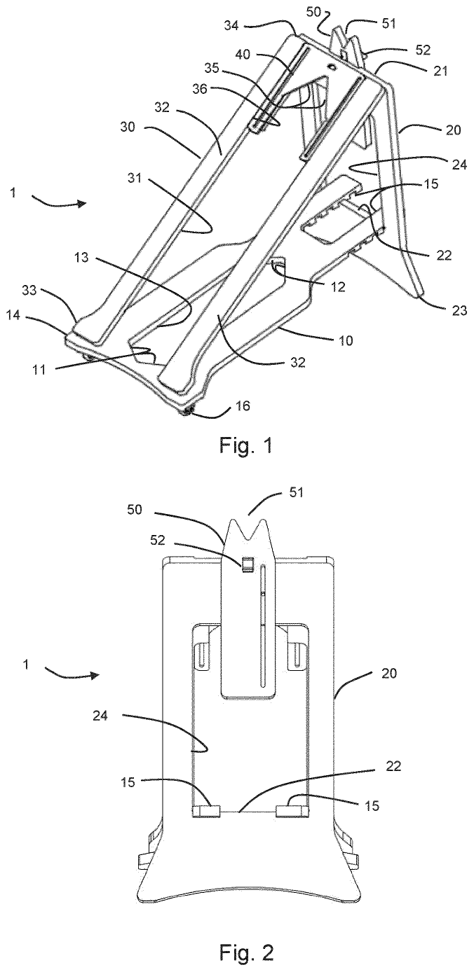

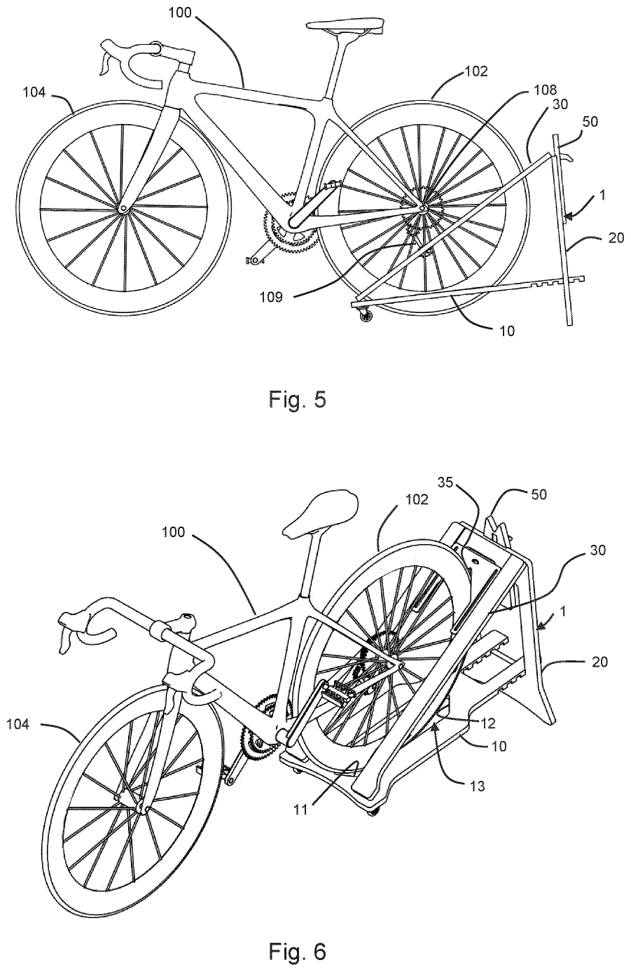

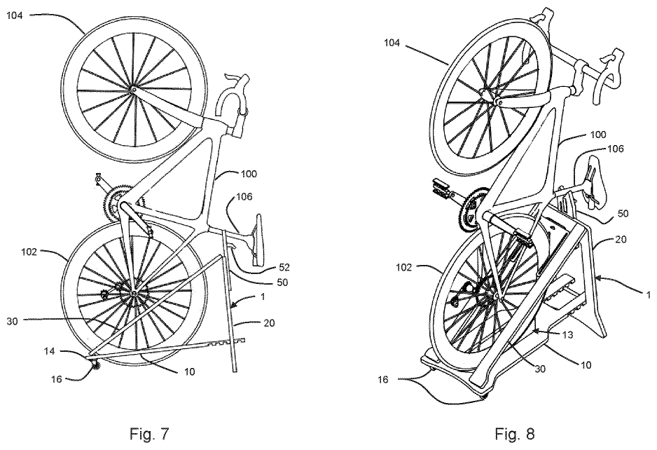

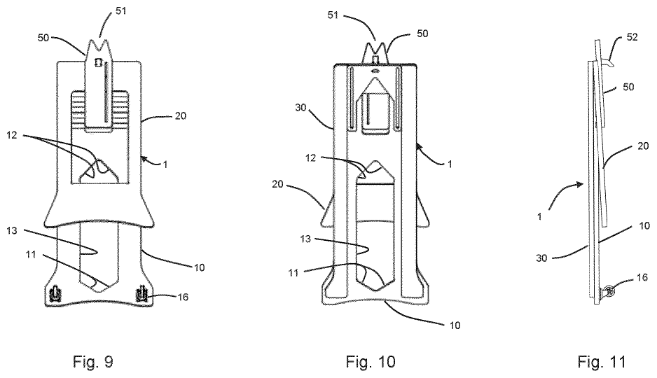

Referring to FIGS. 1 to 11, there are shown a number of schematic views of a first example of a folding stand 1 for a bicycle. FIGS. 1 to 8 show the stand 1 in a deployed configuration. FIGS. 5 and 6 show a bicycle 100 located in the stand 1 with the bicycle 100 generally in a horizonal orientation. FIGS. 7 and 8 show a bicycle 100 located in the stand 1 with the bicycle 100 generally in a vertical orientation. FIGS. 9 to 11 show the stand 1 in a folded configuration.

The stand 1 is particularly intended to be used on a supporting surface, which is typically a horizontal supporting surface such as the floor of a vehicle or horizontal ground.

The stand 1 has three main structural parts, referred to here as a first member 10, a second member 20 and a third member 30. Each member 10, 20, 30 is formed of one or more flat sheets of material. Each member 10, 20, 30 is preferably substantially rigid. Suitable materials include wood (including for example plywood), metal (including for example steel and aluminium) and plastics (including for example polypropylene). One or more openings may be formed in one or more of the sheets of material of the members 10, 20, 30 as discussed further below.

The first member 10 is a lower member in the deployed configuration of the stand 1. In the deployed configuration, the first member 10 is normally horizontal, or at least generally or approximately horizontal (typically within a few degrees, such as within around 10° or up to around 20°, of horizontal). The second member 20 is a rear, generally upwardly directed member in the deployed configuration of the stand 1. The third member 30 is a cross-member in the deployed configuration of the stand 1. The third member 30 is normally inclined to the horizontal in the deployed configuration of the stand 1 and, in particular, is inclined relative to the first member 10 and the second member 20 in the deployed configuration of the stand 1. The third member 30 may be inclined at an angle in the range approximately 30° to 60° to the horizontal, preferably around 45° to the horizontal.

The first member 10 has a front pair of cooperating locating surfaces 11 and a rear pair of cooperating locating surfaces 12 for locating the wheel of a bicycle 100 between the pairs of cooperating surfaces 11, 12. One side or portion of the wheel of a bicycle 100 is located between the front pair of cooperating locating surfaces 11 and an opposite side or portion of the wheel of a bicycle 100 is located between the rear pair of cooperating locating surfaces 12. In the example shown, each pair of cooperating surfaces 11, 12 is formed as opposite sides of a recess, here a V shape recess, provided at opposite ends of a central opening 13 in the first member 10. An advantage of using V shape recesses, or some other tapering or converging shape recess, is that wheels of differing widths and differing diameters can be accommodated more easily. In the example shown, the V shape pairs of cooperating surfaces 11, 12 are in the plane of the first member 10 and the open parts of the respective V shapes oppose each other to receive the bicycle wheel therebetween. As seen most clearly in FIGS. 6 and 8, in use, the wheel of the bicycle 100 passes partly into the central opening 13 in the first member 10 and a lowermost part of the wheel is held front and back by the respective pairs of cooperating surfaces 11, 12. As will be discussed further below, conveniently it is the rear wheel 102 of the bicycle 100 that is located in the central opening 13 in the first member 10 between the respective pairs of cooperating surfaces 11, 12. Nevertheless, as an alternative, the user can locate the front wheel 104 of the bicycle 100 located in the central opening 13 in the first member 10, especially if the bicycle 100 is only stored in a horizonal orientation.

The third member 30 has a central opening 31, through which (part of) the wheel of the bicycle 100 passes as the bicycle 100 is loaded onto the stand 1 and particularly as the wheel is moved to be located in the central opening 13 in the first member 10 through which (part of) the wheel of the bicycle 100 passes as the bicycle 100 is unloaded from the stand 1. The central opening 31 may be closed at each end. More conveniently, the central opening 31 is open at at least the lower end which means it is easier to roll the bicycle wheel into and out of the stand 1. The third member 30 may be formed of a single generally inverted U-shape to provide the central opening 31 between the arms 32 of the U-shape third member 30, with the central opening 31 being open at the lower end. As an alternative, the third member 30 may be formed of two separate arms 32 which are generally parallel and spaced from each other to provide the central opening 31.

The first member 10 is pivotally connected at a first end 14 to a first end 33 of the third member 30. Here, the first end 14 of the first member 10 may be regarded as a front end 14, and the first end 33 of the third member 30 may be regarded as a lower end 33. See FIG. 1. In the case that the third member 30 is U-shape or formed of two separate parts, each arm 32 of the third member 30 may be pivotally connected at its lower end to the first member 10. In any event, the pivotal connection allows the first member 10 and the third member 30 to pivot relative to each other at the pivot point(s), in turn contributing to the stand 1 being foldable. The first member 10 may be pivotally connected to the third member 30 by one or more hinges or some other linking connection.

The third member 30 is pivotally connected at a second end 34 to a first end 21 of the second member 20. Here, the second end 34 of the third member 30 is at the other end from the first end 33, and may be regarded as an upper end 34. The first end 21 of the second member 20 may be regarded as an upper end 21. Similar to the above, in the case that the third member 30 is formed of two separate parts, each arm 32 of the third member 30 may be pivotally connected at its upper end to the first end 21 of the second member 20. The third member 30 may be pivotally connected to the second member 20 by one or more hinges or some other linking connection.

Finally for the basic connections of the first, second and third members 10, 20, 30, the first member 10 is connectable to the second member 20 at a second end 15 of the first member 10. The second end 15 of the first member 10 is at the other end of the first member 10 from the first end 14 and may be regarded as being a rear end 15 of the first member 10. In the example shown, the first member 10 is connectable to the second member 20 at a location 22 on the second member 20 which is somewhat away from (above) a second, lower, end 23 of the second member 20. The location 22 may be for example less than around 25% of the distance from the second, lower, end 23 of the second member 20 to the first, upper, end 21 of the second member 20.

The first member 10 is detachably connectable to the second member 20. With the pivotal connections of the first member 10 to the third member 30 and the third member 30 to the second member 20, this allows the stand 1 to be reconfigured between a folded configuration and a deployed configuration.

In particular, when the stand 1 is in the deployed configuration (e.g. FIG. 1), the user can disconnect the first member 10 from the second member 20, and then fold the first member 10 about the pivotal connection with the third member 30 and then fold the second member 20 about the pivotal connection with the third member 30. Here, the first member 10 is folded “inwards” towards the third member 30 and likewise the second member 20 is folded “inwards” towards the third member 30. The effect of this is that in the in the folded configuration, the first, second and third members 10, 20, 30 are stacked generally one above the other. This is shown in for example FIGS. 9 to 10 which respectively show a plan view from above, a plan view from below and a side elevation of the stand 1 in a folded configuration. This provides a compact and tidy arrangement for the stand 1 in the folded configuration.

Conversely, when the stand 1 is in the folded configuration (e.g. FIG. 11), the user can unfold the second member 20 about the pivotal connection with the third member 20 and unfold the first member 10 about the pivotal connection with the third member 30 to open up the stand 1. The user then connects the second (rear) end 15 of the first member 10 to the second member 20 at the location 22 on the second member 20. The stand 1 is then back in the deployed configuration in which the first member 10 is generally horizontal, the second member 10 is generally upwardly directed and the third member 30 is generally inclined to form a cross-member between the first and second members 10, 20.

In the example shown, the third member 30 provides a third pair of cooperating locating surfaces 35 for locating the wheel of a bicycle 100 between the cooperating surfaces 35. The third pair of cooperating locating surfaces 35 are at or towards the second, upper, end 34 of the third member 30.

The third pair of cooperating locating surfaces 35 provide additional support and stability for locating the wheel of a bicycle 1 as an upper part of the rearmost portion of a wheel can be located in and retained by the third pair of cooperating locating surfaces 35. This can be seen in FIG. 6 for example. Notably, in this example, the wheel is trapped between three pairs of cooperating locating surfaces 11, 12, 35, where two of the pairs of cooperating locating surfaces 11, 12 are below and respectively in front of and behind the centre point of the wheel and the third pair of cooperating locating surfaces 35 is above the centre point of the wheel. This provides increased stability for holding the bicycle 100 in the stand 1. (It will be understood that for very large wheels and/or tyres, this particular configuration may not be achievable, but for most wheels and tyres, of typical “standard” size, this particularly stable configuration of the cooperating locating surfaces 11, 12, 35 will apply.)

Further, in the example shown, the third pair of cooperating locating surfaces 35 are provided on a sliding member 40. The sliding member 40 is slidably fixed to the third member 30 to be slidable along the third member 30. This may be achieved for example by the sliding member 40 running in recesses of channels or grooves 36 or the like provided on the third member 30. The sliding member 40 allows the relative location of the third pair of cooperating locating surfaces 40 on the third member 30 to be adjusted. In turn, this allows wheels of different sizes to be accommodated by the stand 1 more easily and securely.

In the example shown, the third pair of cooperating locating surfaces 35 is formed as opposite sides of a recess, here again a V or other tapering or converging shape recess, provided in the sliding member 40, where the open part of the V faces generally downwards and forwards, towards the front cooperating locating surfaces 11 of the first member 10.

As can be understood from for example FIGS. 5 and 6, when a bicycle 100 is loaded into the stand 1, the bicycle 1 may be pushed in rear wheel 102 first. The rear wheel 102 is lifted or rides over any front part of the first (lower) member 10 and drops into the central opening 13 to be held at the front by the front cooperating locating surfaces 11 and at the back by the rear cooperating locating surfaces 12 of the first member 10. An upper part of the wheel is held by the third cooperating locating surfaces 35 of the third member 30. The sliding member 40 can be slid up or down the third member 30 as necessary to fit the third cooperating locating surfaces 35 over the upper part of the wheel. The bicycle 100 is then held securely and stably in the stand 1 generally in a horizonal orientation.

Whilst in many cases, it may be convenient for the bicycle 100 to be stored in the stand 1 generally in a horizonal orientation, in some cases it may be more convenient for the bicycle 100 to be stored in the stand 1 generally in a vertical orientation. In this case, the overall footprint (plan area when viewed from above) is smaller. This may be convenient if for example the bicycle 100 and stand 1 are being used in a smaller location, such as in a room in a house or a compact bicycle shed, van, etc. In this case, the user can rotate the bicycle 100 approximately 90° about the axle of the rear wheel 102 whilst the bicycles 100 is in the stand 1 to orient the bicycle 100 vertically. FIGS. 7 and 8 show the bicycle 100 located in the stand 1 with the bicycle 100 generally in a vertical orientation.

The present stand 1 provides a further advantage as it is convenient for the user to have the bicycle 100 initially stored horizontally. This is because the user can load the bicycle 100 into the stand 1 and first remove any bicycle bags or panniers or the like, water bottles, or to conduct pre and post ride basic maintenance like oiling the chain or adjusting brakes etc, and then rotate the bicycle 100 to the vertical orientation.

In the vertical orientation, the rear wheel 102 of the bicycle 100 remains held between the front pair of cooperating locating surfaces 11 and the rear pair of cooperating locating surfaces 12 provided by the first, lower, member 10. The rear wheel 102 of the bicycle 100 may also be held between the rear pair of cooperating locating surfaces 35 provided by the third member 30. To provide additional stability and security for the bicycle 100 in the stand 1 in the vertical orientation, the stand 1 in this example has a seat post support 50 for supporting a seat post 106 of the bicycle 100 when the bicycle 100 is in the vertical orientation. The seat post support 50 is mounted at or towards the first, upper, end 21 of the second member 20 to project beyond the first end 21 of the second member 20 when the stand 1 is in the deployed configuration. An upper part of the seat post support 50 has a recess 51, here again a V or other tapering or converging shape recess. The recess 51 faces generally upwards when the stand 1 is in the deployed configuration and receives the seat post 106 of the bicycle 100 when the bicycle 100 is rotated to the vertical orientation. This provides an additional point of contact to secure the bicycle 100 in the deployed stand 1 when the bicycle 100 is in the vertical orientation. The use of the seat post support 50 for supporting a seat post 106 of the bicycle 100 when the bicycle 100 is in the vertical orientation may be in addition to or instead of holding the rear wheel 102 of the bicycle 100 between the rear pair of cooperating locating surfaces 35 provided by the third member 30.

The seat post support 50 in this example is arranged to be slidable along the second member 20. This allows the location of the seat post support 50 on the second member 20 to be adjusted. This therefore allows the height of the recess 51 of the seat post support 50 to be adjusted, which allows bicycles of different sizes and different configurations to be accommodated by the stand 1 when stored in the vertical orientation in the deployed stand 1. The seat post support surface 50 may be provided as a separate slider component which is slidably fixed to the second member 20. This may be achieved for example by the seat post support surface 50 running in one or more grooves or channels or the like provided along the second member 20. A lock screw and nut arrangement (not shown) or similar passing through the seat post support surface 50 and the second member 20 may be provided to allow the user to lock the seat post support surface 50 at the desired position along the second member 20.

As another feature, the seat post support surface 50 of this example has a rearwardly facing projection 52, here located below the recess 51 which receives the seat post 106 of the bicycle 100. Referring for example to FIG. 7, the rearwardly facing projection 52 enables a user to place a hand around the rearwardly facing projection 52 and the seat post 106 to grasp and hold the bicycle and stand together. Alternatively, the user can wrap a strap or the like around the rearwardly facing projection 52 and the seat post 106 to hold the bicycle 100 and stand 1 together. Either way, this provides a convenient way for the user to move and manoeuvre the bicycle 100 and stand 1 together, whilst securing the bicycle 100 in the stand 1 during movement.

To facilitate movement of the bicycle 100 in the stand 1 together, the stand 1 may have one or more wheels or rollers 16 provided on the lower surface of the first, lower, member 10. The one or more wheels or rollers 16 are conveniently provided towards the front end of the first, lower, member 10. Referring for example to FIG. 7 again, the user can grasp the rearwardly facing projection 52 and the seat post 106 to hold the bicycle 100 on the stand 1 and lift the second, rear, member 20 off the ground. The user can then move the bicycle 100 and the stand 1 together, using the one or more wheels or rollers 16 in the manner of a wheeled trolley or wheelbarrow or the like.

To further facilitate movement of the bicycle 100 in the stand 1 together, in an example the stand 1 may be arranged so that the wheel of the bicycle 100 is held off the ground when the wheel is located between the lower pairs of locating surfaces 11, 12. In particular, the front pair of cooperating locating surfaces 11 and the rear pair of cooperating locating surfaces 12 may be spaced from each other such that the wheel is held off the ground. Whilst ultimately this may depend on the diameter of the wheel of the bicycle 100, as well as the type of tyre fitted to the wheel, the combination of the wheel and tyre of many bicycles have the same or similar diameters. For example, the outer diameter of the combination of the wheel and tyre for many bicycle wheels is in the range 26 inches (approximately 660 millimetres) to 29 inches (approximately 735 mm). A distance between the front pair of cooperating locating surfaces 11 and the rear pair of cooperating locating surfaces 12 in the range around 435 millimetres to around 485 millimetres, or in particular of around 460 millimetres, has been found to accommodate a wide range of standard bicycle wheels and tyres.

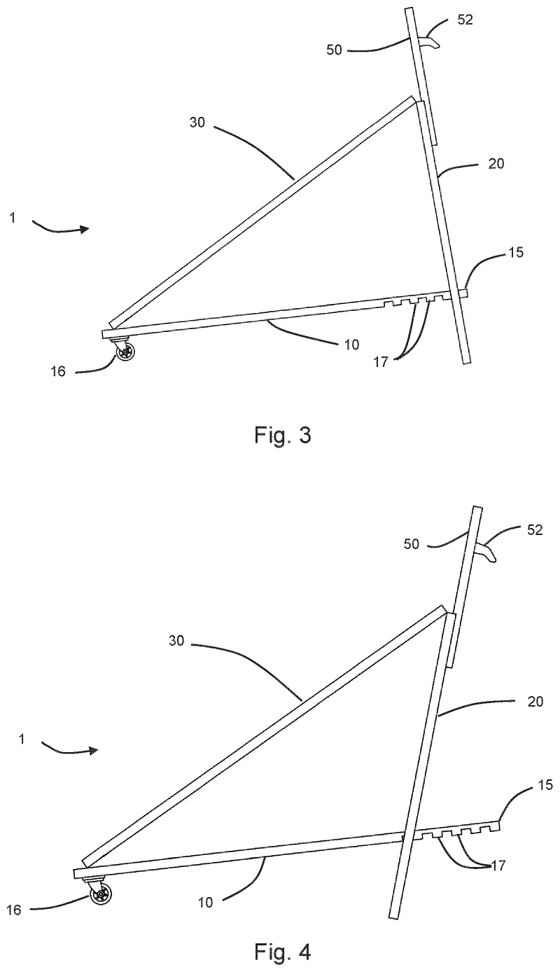

As mentioned, the rear end 15 of the first member 10 is connectable to and disconnectable from the second member 20 at a location 22 on the second member 20 which is somewhat away from (above) the lower end 23 of the second member 20. To allow bicycles of different sizes and different configurations to be accommodated, in an example the first member 10 and the second member 20 are arranged such that the first member 10 is connectable to the second member 20 at a number of different locations along the first member 10. This means that the angle of inclination of the second member 20 is adjustable. In turn, in the case that the stand 1 has a seat post support 50, varying the angle of inclination of the second member 20 allows the relative location of the seat post support 50 to be adjusted back and forth. This can be seen most clearly by a comparison of FIGS. 3 and 4, which show side elevations of the stand 1 in the deployed configuration in a first arrangement and a second arrangement respectively. In FIG. 3, the first member 10 is connected to the second member 20 towards the rear end 15 of the first member 10. The second member 20 and the seat post support 50 are therefore inclined inwards (to the left in FIG. 3). In FIG. 4, the first member 10 is connected to the second member 20 rather inwards of the rear end 15 of the first member 10. The second member 20 and the seat post support 50 are therefore inclined outwards (to the right in FIG. 3).

In general, the first member 10 may be connected to the second member 20 at a number of different locations between the extremes shown in FIGS. 3 and 4. This allows the angle of inclination of the second member 20 and therefore the location of the seat post support 50 to be set to accommodate a range of bicycles of different sizes and different configurations. In an example, this is achieved by the second member 20 having a cross bar 22 towards the lower end 23 of the second member 20. The cross bar 22 provides the location 22 where the first member 10 connects. The cross bar 22 may be provided as the lower wall of an opening 24 in the second member 20 through which the rear end 15 of the first member 10 passes. The rear end 15 of the first member 10 lies across the cross bar 22 when the stand 1 is in the deployed configuration. In this example, the first member 10 has a plurality of ridges or stops 17 on the lowermost surface towards the rear end 15, running from one long side of the first member 10 to the other. The ridges or stops 17 provide the different locations along the first member 10 and respectively abut against the cross bar 22 of the second member 20 when the stand is in the deployed configuration. The user simply has to lift the first member 10 and push it through the opening 24 in the second member 20 to the desired extent and then drop or push down the first member 10 to engage the relevant ridges or stops 17 on the first member 10 with the cross bar 22 on the second member 20. It may be noted that the weight of the bicycle 100 in the stand 1 helps to keep the first member 10 locked in position on the second member 20.

As noted above, the wheel of the bicycle 100 passes partly into the central opening 13 in the first member 10 and a lowermost part of the wheel is held front and back by the respective pairs of cooperating surfaces 11, 12. Typically, the stand 1 is arranged such that the axle 108 of the wheel does not pass through the central opening 31 of the third, inclined, cross member 30. A further feature is that in the example shown, the central opening 13 in the first member 10 is off centre, that is, to the side of the longitudinal axis of the first member 10. This helps to avoid the gear mechanism 109, such as for example a “derailleur” or other gear mechanism, striking or fouling on the third member 30 as the bicycle 100 is loaded into and stored in the stand 1.

The stand 1 of FIGS. 1 to 11 allows bicycles of a range of different sizes and different configurations to be accommodated by the stand 1. The bicycle can be stored in a horizontal or a vertical orientation, whilst still being held securely and stably by the stand 1. Examples allow the user to easily move and manoeuvre the bicycle and stand 1 together, whilst securing the bicycle 100 in the stand 1 during movement. The stand 1 is easily folded down to a compact folded configuration for storage and transport when not in use.

A problem with storing a bicycle vertically in a bicycle stand is that the handlebar of the bicycle can rotate back and forth and drop down to one side or the other. This can be a hazard, especially if the bicycle and stand are in a confined location where people, including children, are moving around, such as in a domestic dwelling.

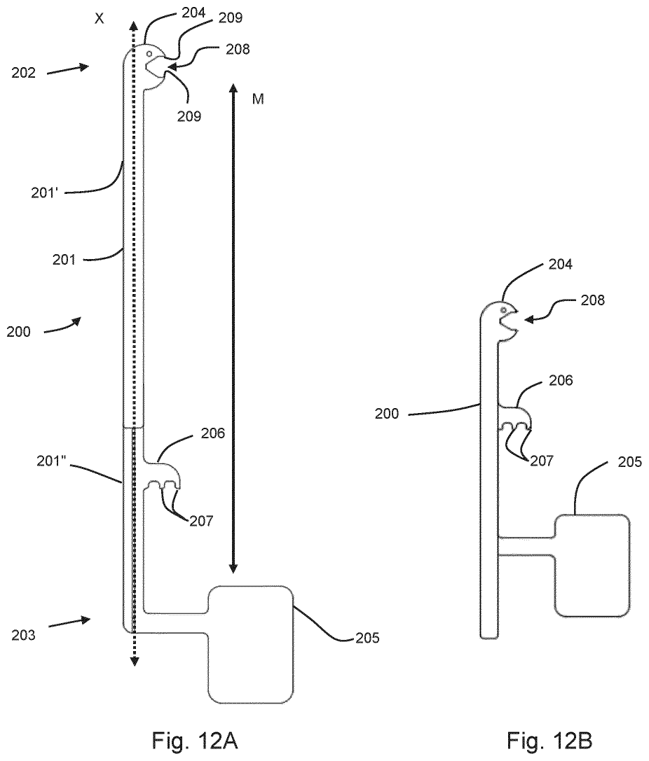

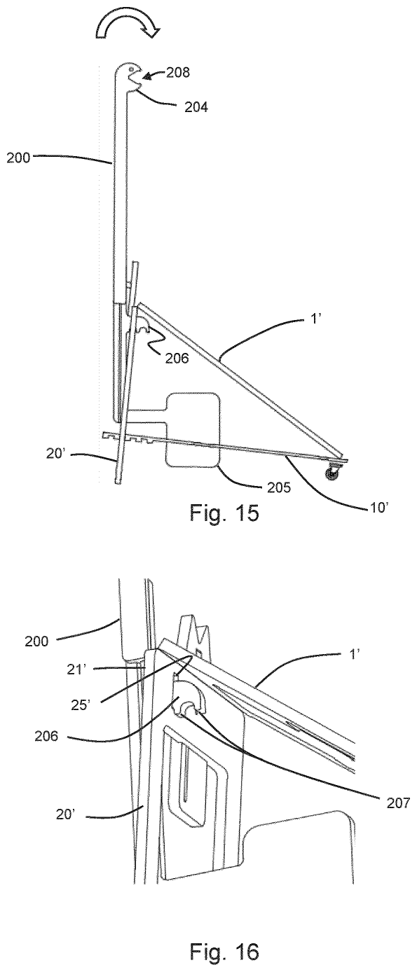

Referring to FIGS. 12 to 20, there are shown a number of schematic views of an example of a handlebar stabiliser 200 for stabilising the handlebar of a bicycle. The handlebar stabiliser 200 may in general be used in conjunction with a range of different bicycle stands. The handlebar stabiliser 200 shown is particularly adapted for use with a second example of a bicycle stand which is similar to the bicycle stand 1 described above but with one or more additional features as discussed further below.

Referring particularly to FIGS. 12A and 12B first, the handlebar stabiliser 200 has an elongate member 201 having a first end 202 and a second end 203. The elongate member 201 is in the form of a rod or the like. The elongate member 201 may be formed of two or more parts 201′, 201″ arranged in a telescopic manner. This allows the overall length of the elongate member 201 to be adjusted, in order to accommodate bicycles of different sizes and different configurations as will become clear. The two or more parts 201′, 201″ can be locked to each other at the desired length of the elongate member 201. In use, the first end 202 is an upper end and the second end 203 is a lower end.

The handlebar stabiliser 200 has a jaw 204 which is at or towards the first, upper, end 202 of the elongate member 201. The jaw 204 projects outwardly of the elongate member 201, that is, in a direction generally perpendicular to the longitudinal axis X of the elongate member 201. In use, as will be seen, the jaw 204 fits over a handlebar of a bicycle.

The handlebar stabiliser 200 further has a biasing weight 205 which is at or towards the second, lower, end 203 of the elongate member 201. The biasing weight 205 projects outwardly of the elongate member 201, that is, in a direction generally perpendicular to the longitudinal axis X of the elongate member 201. The biasing weight 205 is relatively heavy so as to be able to pivot the jaw 204 forwards to engage a handlebar of a bicycle as will be discussed. The biasing weight 205 may be relatively large and/or formed of or include a dense material, such as a metal, so as to have a relatively large mass.

Finally, the handlebar stabiliser 200 has a pivot mount 206 between the first and second ends 201, 202 of the elongate member 201. The pivot mount 206 projects outwardly of the elongate member 201, that is again, in a direction generally perpendicular to the longitudinal axis X of the elongate member 201. The pivot mount 206 is used to pivotally support the handlebar stabiliser 200 on a bicycle stand, as will be discussed. The pivot mount 206 of this example has one or more stops or teeth 207 or the like which retain the pivot mount 206 on the bicycle stand.

It is noted that the jaw 204, the biasing weight 205 and the pivot mount 206 all project outwardly of the elongate member 201 in the same direction, that is, all project from the same side of the elongate member 201. By virtue of the mass of the biasing weight 205, and because the biasing weight 205 projects further than the pivot point provided by the pivot mount 206, the centre of mass of the handlebar stabiliser 200 is to the same side of the elongate member 201 as the jaw 204, the biasing weight 205 and the pivot mount 206. Notably and as illustrated particularly in FIG. 12A, the centre of mass of the handlebar stabiliser 200 lies on a line M that is parallel to the longitudinal axis X of the elongate member 201 and beyond (outwardly of) the pivot point provided by the pivot mount 206. For increased stability, the centre of mass of the handlebar stabiliser 200 is preferably below the pivot point provided by the pivot mount 206 (i.e. on the side of the pivot mount 206 towards the biasing weight 205).

The elongate member 201, the jaw 204, the biasing weight 205 and the pivot mount 206 may be integrally formed as one item. In the example shown where the elongate member 201 is formed of two or more parts 201′, 201″ arranged in a telescopic manner, the jaw 204 is provided on and integral with the upper part 201′ and the biasing weight 205 and the pivot mount 206 are provided on and integral with the lower part 201″. As another variant, the jaw 204 may be a separate part which is fitted to the elongate member 201, using for example a lock nut and bolt or some other arrangement. This allows fine adjustment of the position of the jaw 204 to match the height of the handlebar and also allows jaws 204 of different shapes and sizes to be easily swapped in and out, which allows handlebars of different shapes and sizes to be accommodated. The handlebar stabiliser 200 may be sold with a number of different, replaceable jaws 204, of different shapes and sizes and the user simply attaches the one that is most appropriate for the bicycle concerned.

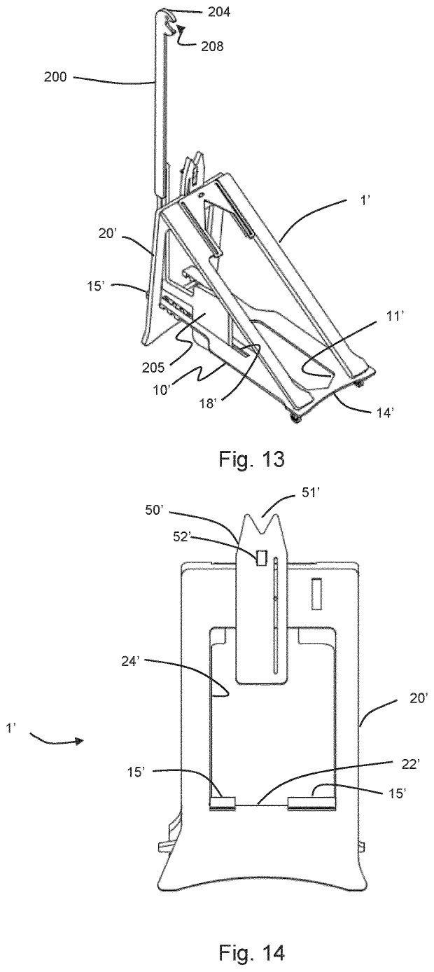

As mentioned, the handlebar stabiliser 200 may in general be used in conjunction with a range of different bicycle stands. However, the handlebar stabiliser 200 shown is particularly adapted for use with a second example of a bicycle stand which is similar to the bicycle stand 1 described above but with one or more additional features as discussed further below. This will be discussed now with particular reference to FIGS. 13 to 20. The second example of a bicycle stand 1′ shown has the same reference numerals for the same or corresponding parts and features but with a prime (′). Not all of the reference numerals are shown in FIGS. 13 to 20 for clarity and the description of the same or corresponding parts as the bicycle stand 1 described above is not repeated here for brevity.

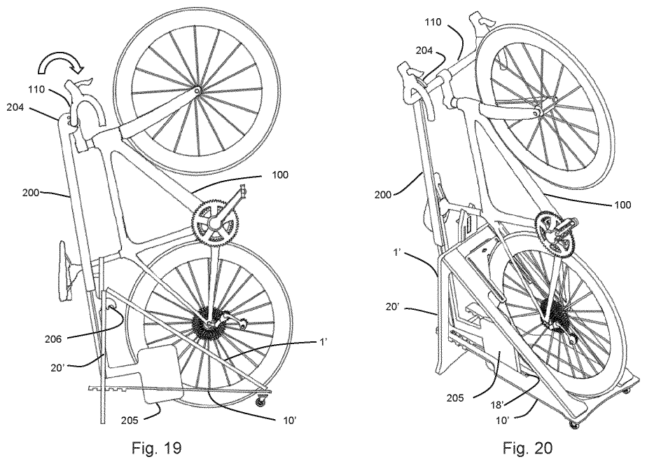

In short, the handlebar stabiliser 200 is fitted to the stand 1′ by fitting the pivot mount 206 to the stand 1′ such that the elongate member 201 is generally vertical with the biasing weight 205 being lowermost and the jaw 204 uppermost. The biasing weight 205 biases the elongate member 201 to rotate about the pivot point provided by the pivot mount 206. That is, because the centre of mass of the handlebar stabiliser 200 lies on a line M that is parallel to the longitudinal axis X of the elongate member 201 and beyond (outwardly of) the pivot point provided by the pivot mount 206, the biasing weight 205 biases the elongate member 201 to rotate (in a clockwise direction in FIGS. 15 and 19 as indicated by the arrow). Referring particularly to FIGS. 19 and 20, this biases the jaw 204 into engagement with a handlebar 110 of a bicycle 100 located generally vertically in the stand 1′. The jaw 204 receives the handlebar 110 and stabilises the handlebar 110 to prevent or inhibit movement of the handlebar 110 when the bicycle 100 is located vertically in the stand 1′. Most preferably, the handlebar 110 is held by the jaw 204 such that the handlebar 110 is substantially horizontal, and rocking or pivoting of the handlebar 110 about a horizontal axis provided by the handlebar stem is inhibited by the jaw 204. Further, it is noted the handlebar stabiliser 200 is fitted to and arranged on the stand 1′ such that, when the handlebar stabiliser 200 pivots, the jaw 204 approaches the handlebar 110 from “above” the handlebar 110 (from the left in FIG. 19). This makes it less likely that the jaw 204 hits or traps brake and gear cables and the like as the jaw 204 moves into position over the handlebar 110.

As can be seen in the figures, the jaw 204 provides a mouth or recess 208 which receives the handlebar 110 to engage and hold the handlebar 110. The recess 208 has a generally V or other tapering or converging shape which receives the handlebar 110. In the particular example shown, the entrance to the recess 208 has a pair of opposed flat surfaces 209 which are parallel to each other and perpendicular to the longitudinal axis X of the elongate member 201, to be substantially or generally horizontal in use. These opposed flat surfaces 209 of the jaw 204 can bear against the handlebar 110 and assist in preventing rocking or pivoting of the handlebar 110, especially if the handlebar 110 is knocked sharply.

It is noted that when the user rotates the bicycle 100 from the initial horizontal orientation to the vertical orientation, the elongate member 201 may be rotated backwards either manually by the user or by being pushed back by the bicycle 100. Then when the bicycle 100 is properly oriented vertically, the jaw 204 is biased into engagement with the handlebar 116. As mentioned, the elongate member 201 may be telescopic which allows the user to adjust the overall length of the elongate member 201 to fit correctly around the handlebar 116, depending on the size and configuration of the bicycle 100.

As mentioned, the second example of a bicycle stand 1′ is similar to the bicycle stand 1 described above but with one or more additional features, as will now be discussed. It should be noted that these features may be provided in other stands of different configurations which hold a bicycle vertically, and these features are not limited to stands that have all of the features of the first example stand 1 described above.

As one feature and as shown most clearly in FIGS. 13, 18 and 20, the first, lower, member 10′ has an elongate slot 18′ which extends from a point close to the second (rear) end 15′ towards the first (front) end 14′ of the lower member 10′. The slot 18′ may for example extend approximately half way along the length of the lower member 10′. When the handlebar stabiliser 200 is fitted to the stand 1′, the biasing weight 205 of the handlebar stabiliser 200 is received in the slot 18′. This therefore restrains sideways movement of the handlebar stabiliser 200 while permitting pivoting movement of the handlebar stabiliser 200 about the pivot point. It is noted that in this case, the biasing weight 205 of the handlebar stabiliser 200 is of a size and shape to be able to be received in the slot 18′ whilst being able to move back and forth within the slot 18′. In the example shown, the biasing weight 205 is generally flat and planar, with the plane of the biasing weight 205 being arranged vertically in use to fit into the slot 18′.

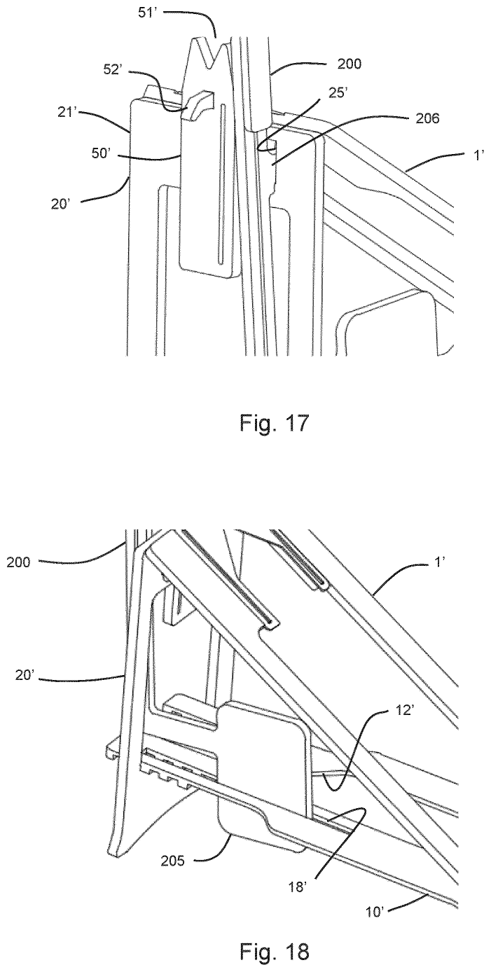

As a second feature, the second, rear, member 20′ has a slot 25′ which receives the pivot mount 206 of the handlebar stabiliser 200. Whilst the pivot mount 206 could be simply rested on top of the second member 20′, a slot 25′ for the pivot mount 206 provides for a more secure fixing of the handlebar stabiliser 200 to the stand 1′. As shown most clearly in FIGS. 16 and 17, the slot 25′ for the pivot mount 206 of the handlebar stabiliser 200 is located towards the first (upper) end 21′ of the second member 20′. The pivot mount 206 passes into the slot 25′ and a lower wall of the slot 25′ is received between adjacent ones of the stops or teeth 207 of the pivot mount 206. This provides a secure connection for the handlebar stabiliser 200 to the stand 1′, permitting pivoting movement of the handlebar stabiliser 200 about the pivot point whilst restraining sideways movement of the handlebar stabiliser 200.

As an option and where provided, the slot 18′ in the lower member 10′ for the biasing weight 205 and the slot 25′ in the rear member 20′ for the pivot mount 206 are located laterally displaced from a line between the front pair of cooperating locating surfaces 11′ and the rear pair of cooperating locating surfaces 12′ of the lower member 10. This means that the handlebar stabiliser 200 is located parallel to and spaced from the plane of a bicycle 100 located generally vertically in the stand 1′. In turn, this means that the jaw 204 fits over the handlebar 110 of the bicycle 100 at a position spaced from the centre of the handlebar 110. This can be seen most clearly in FIG. 20. This allows the jaw 204 to fit over the handlebar 110 more easily as the bicycle 100 is rotated to the vertical orientation and the jaw 204 moves forward by rotation of the handlebar stabiliser 200. It also means that the jaw 204 is less likely to hit or trap brake and gear cables and the like which often run over or near the centre of the handlebar 110. Finally, this also means that the handlebar 110 is held more securely by the jaw 204 and rotation of the handlebar 110 is better prevented.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A folding stand for locating a bicycle, the folding stand being foldable to a folded configuration and deployable to a deployed configuration, the folding stand comprising:
at least first, second and third members;
the first member being a lower member in the deployed configuration of the folding stand and having a front pair of cooperating locating surfaces and a rear pair of cooperating locating surfaces for locating the wheel of a bicycle between the cooperating surfaces;
the second member being a rear, generally upwardly directed member in the deployed configuration of the folding stand;
the third member being a cross-member in the deployed configuration of the folding stand;
the first member being pivotally connected at a first end to a first end of the third member;
the third member being pivotally connected at a second end to a first end of the second member;
the first member being connectable at a second end to the second member;
such that the folding stand can be folded to the folded configuration by disconnecting the second end of the first member from the second member and folding the first member about the pivotal connection with the third member and folding the second member about the pivotal connection with the third member, wherein the first, second and third members are stacked generally one above the other in the folded configuration; and
such that the folding stand can be deployed to the deployed configuration by unfolding the second member about the pivotal connection with the third member and unfolding the first member about the pivotal connection with the third member and connecting the second end of the first member to the second member, wherein the first member is generally horizontal, the second member is generally upwardly directed and the third member is generally inclined to form a cross-member between the first and second members.

2. A folding stand according to claim 1, wherein the third member provides a third pair of cooperating locating surfaces at or towards the second end of the third member for locating the wheel of a bicycle between the cooperating surfaces.

3. A folding stand according to claim 2, wherein the third pair of cooperating locating surfaces are provided on a sliding member which is arranged to be slidable along the third member to allow the location of the third pair of cooperating locating surfaces on the third member to be adjusted.

4. A folding stand according to claim 1, comprising a seat post support for supporting a seat post of a bicycle, the seat post support being mounted at or towards the first end of the second member to project beyond the first end of the second member when the folding stand is in the deployed configuration to receive a seat post of a bicycle when the bicycle is stored in a generally vertical orientation in the deployed stand.

5. A folding stand according to claim 4, wherein the seat post support is arranged to be slidable along the second member to allow the location of the seat post support on the second member to be adjusted.

6. A folding stand according to claim 4, comprising a rearwardly facing projection on the seat post support.

7. A folding stand according to claim 1, the folding stand comprising at least one wheel or roller on the first member to facilitate movement of the folding stand by a user.

8. A folding stand according to claim 1, wherein the first member and the second member are arranged such that the first member is connectable to the second member at a number of different locations along the first member, such that the angle of inclination of the second member is adjustable.

9. A folding stand according to claim 8, wherein the second member has a cross bar towards the second end of the second member and the second end of the first member lies across the cross bar when the folding stand is in the deployed configuration, the first member comprising a plurality of ridges or stops on a lowermost surface towards the second end of the first member which provide the different locations along the first member and which respectively abut against the cross bar of the second member when the folding stand is in the deployed configuration.

10. A folding stand according to claim 2, comprising a seat post support for supporting a seat post of a bicycle, the seat post support being mounted at or towards the first end of the second member to project beyond the first end of the second member when the folding stand is in the deployed configuration to receive a seat post of a bicycle when the bicycle is stored in a generally vertical orientation in the deployed stand.

11. A folding stand according to claim 10, wherein the seat post support is arranged to be slidable along the second member to allow the location of the seat post support on the second member to be adjusted.

12. A folding stand according to claim 10, comprising a rearwardly facing projection on the seat post support.

13. A folding stand according to claim 3, comprising a seat post support for supporting a seat post of a bicycle, the seat post support being mounted at or towards the first end of the second member to project beyond the first end of the second member when the folding stand is in the deployed configuration to receive a seat post of a bicycle when the bicycle is stored in a generally vertical orientation in the deployed stand.

14. A folding stand according to claim 13, wherein the seat post support is arranged to be slidable along the second member to allow the location of the seat post support on the second member to be adjusted.

15. A folding stand according to claim 13, comprising a rearwardly facing projection on the seat post support.

16. A folding stand according to claim 2, wherein the first member and the second member are arranged such that the first member is connectable to the second member at a number of different locations along the first member, such that the angle of inclination of the second member is adjustable.

17. A folding stand according to claim 16, wherein the second member has a cross bar towards the second end of the second member and the second end of the first member lies across the cross bar when the folding stand is in the deployed configuration, the first member comprising a plurality of ridges or stops on a lowermost surface towards the second end of the first member which provide the different locations along the first member and which respectively abut against the cross bar of the second member when the folding stand is in the deployed configuration.

18. A folding stand according to claim 3, wherein the first member and the second member are arranged such that the first member is connectable to the second member at a number of different locations along the first member, such that the angle of inclination of the second member is adjustable.

19. A folding stand according to claim 17, wherein the second member has a cross bar towards the second end of the second member and the second end of the first member lies across the cross bar when the folding stand is in the deployed configuration, the first member comprising a plurality of ridges or stops on a lowermost surface towards the second end of the first member which provide the different locations along the first member and which respectively abut against the cross bar of the second member when the folding stand is in the deployed configuration.
